(19) United States
(12) Patent Application Publication
(10) Pub. No.: US 2026/0357053 A1
(43) Pub. Date: Nov. 12, 2026

(54) (METH)ACRYLIC COMPOSITION COMPRISING RECYCLED MATERIAL, METHOD FOR PRODUCING SAID COMPOSITION AND USES THEREOF

(71) Applicant: Arkema France, Puteaux (FR)

(72) Inventors: Pierre GERARD, LACQ (FR); Alexander ZOLLER, Lacq (FR); Pierre ESCALE, LACQ (FR); Jean-François DEVAUX, PIERRE-BENITE Cedex (FR); Julien JOUANNEAU, PIERRE-BENITE Cedex (FR)

(73) Assignee: Arkema France, Puteaux (FR)

(21) Appl. No.: 19/134,857

(22) PCT Filed: Dec. 2, 2023
(86) PCT No.: PCT/EP2023/084026

§ 371 Date: Jun. 2, 2025

(30) Foreign Application Priority Data
Dec. 2, 2022 (FR) 2212697

(51) Int. Cl. C08L 33/12; C08J 5/24

(52) U.S. Cl. CPC C08L 33/12; C08J 5/244; C08J 2333/12; C08J 2433/12; C08L 2205/025; C08L 2207/20

(57) ABSTRACT

The present invention relates to a (meth)acrylic composition comprising recycled materials, a process for preparing the (meth)acrylic composition and uses of such a (meth)acrylic composition.

In particular the present invention relates to a (meth)acrylic composition comprising a recycled material or recycled materials, said recycled materials are either in polymeric form or monomers or both, a process for preparing the (meth)acrylic composition and uses of such a (meth)acrylic composition.

The invention also relates also (meth)acrylic polymeric composite material, comprising or made of a (meth)acrylic composition comprising recycled materials, a method for preparing such (meth)acrylic composite material comprising or made of a (meth)acrylic composition comprising recycled materials and an object comprising such (meth)acrylic polymeric composite material comprising or made of a (meth)acrylic composition comprising recycled materials.

### FIELD OF THE INVENTION

The present invention relates to a (meth)acrylic composition comprising recycled materials, a process for preparing (meth)acrylic composition and uses of such a (meth)acrylic composition.

In particular the present invention relates to a (meth)acrylic composition comprising a recycled material or recycled materials, said recycled materials are either in polymeric form or monomers or both, a process for preparing the (meth)acrylic composition and uses of such a (meth)acrylic composition.

The invention also relates also to a (meth)acrylic polymeric composite material, comprising or made of a (meth)acrylic composition comprising recycled materials, a method for preparing such (meth)acrylic composite material comprising or made of a (meth)acrylic composition comprising recycled materials and an object comprising such (meth)acrylic polymeric composite material comprising or made of a (meth)acrylic composition comprising recycled materials.

### Technical Problem

Many materials are reused and/or recycled in order to reduce waste and for the reason of sustainability or sustainable development. This includes polymeric materials and composite material.

A composite material is a macroscopic combination of two or more non-miscible materials. The composite material constitutes at least of a matrix material, for example a polymeric material, that forms a continuous phase for the cohesion of the structure and a reinforcing material with various architectures for the mechanical properties.

The aim in using composite materials is to achieve a performance from the composite material that is not available from its separate constituents if used alone. Consequently, composite materials are widely used in several industrial sectors as for example building, automotive, nautical or marine, aerospace, transport, leisure, electronics, and sport notably due to their better mechanical performance (higher tensile strength, higher tensile modulus, and higher fracture toughness) in comparison with homogenous materials and their low density.

The most important class in view of volume in commercial industrial scale, are composites with organic matrices, where the matrix material is generally a polymer. The principal matrix or continuous phase of a polymeric composite material is either a thermoplastic polymer or a thermosetting polymer.

One way for preparing a polymeric composite material based on thermoplastic polymers is by using a liquid polymer composition comprising a monomer, commonly known as a “syrup”. Such a syrup is used for blending with a mineral filler or for impregnating the reinforcing material, for example a fibrous substrate; followed by polymerization.

At the end of the use of object or article comprising the composite material, said object or article should be easily recyclable.

There is a need for (meth)acrylic compositions and polymeric (meth)acrylic compositions that comprise raw materials that are recycled while keeping the same characteristics of (meth)acrylic compositions and polymeric (meth)acrylic compositions without any recycled raw materials. The characteristics include viscosity of liquid compositions, reactivity, stability, mechanical properties, thermomechanical properties.

There is a need for (meth)acrylic compositions and polymeric (meth)acrylic compositions that have a reduced carbon footprint. Preferably the carbon footprint expressed in CO2 equivalents is less than 3.5 kg/CO₂ for 1 kg of (meth)acrylic compositions or polymeric (meth)acrylic compositions, more preferably less than 3 kg/CO₂ for 1 kg of (meth)acrylic composition or polymeric (meth)acrylic composition.

There is also a need to propose a process for making (meth)acrylic compositions and polymeric (meth)acrylic compositions that have a reduced carbon footprint.

There is also a need to propose (meth)acrylic compositions and polymeric (meth)acrylic compositions that are more sustainable.

There is also a need of process to prepare (meth)acrylic composite materials that have a reduced carbon footprint.

Another aim of the present invention is to propose a process for manufacturing a polymeric (meth)acrylic composite material that have a reduced carbon footprint, that can be recycled and that comprises already recycled raw materials.

### BACKGROUND OF THE INVENTION

### Prior Art

The document WO2013/056845 discloses a composite material via in-situ polymerization of thermoplastic (meth)acrylic resins. The polymeric composite material obtained by in-situ polymerization of a thermoplastic (meth)acrylic resin and a fibrous material containing long fibers and its use, a process for making such a composite material and manufactured mechanical or structured part or article comprising this polymeric composite material. The document does not disclose anything about use of recycled material and reduction of carbon footprint.

The document WO2014/013028 discloses an impregnation process for a fibrous substrate, a liquid (meth)acrylic syrup for the impregnation process, its method of polymerization and structured article obtained thereof. The liquid (meth)acrylic syrup comprises a (meth)acrylic polymer, a (meth)acrylic monomer and at least one initiator or initiating system for starting the polymerization of the (meth)acrylic monomer. The document does not disclose anything about use of recycled material and reduction of carbon footprint.

The document CN110684470 discloses a method for preparing an adhesive acrylate from monomer wastewater, comprising recovered acrylic acid.

The document US2021/087383 discloses biobased acrylic casting compositions comprising notably one or more monofunctional and polyfunctional acrylic and or methacrylic biomonomers of vegetable or animal origin.

The document JP2000/319443 discloses method of producing a polymer syrup. The method uses waste polymer.

The document CN114920489 discloses a cement raw meal additive. The additive is based on butyl acrylate or comprises butyl acrylate.

None of the cited prior art discloses a liquid (meth)acrylic syrup having a recycled content of at least 1 wt % or comprising one raw material that has been recycled or to reduce carbon food print.

### BRIEF DESCRIPTION OF THE INVENTION

Surprisingly it has been found that a (meth)acrylic composition MC1 comprising:
(a) 100 parts by weight of a liquid (meth)acrylic syrup having recycled content of at least 1 wt %, comprising:
   (a₁) from 18 by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,

(b) optionally from 0.01 part by weight to 5 parts by weight of a polymerization initiator,

(c) optionally between 100 ppm and 10 000 ppm of an accelerator, allows to provide a composition for the preparation of (meth)acrylic polymeric compositions and (meth)acrylic composite materials that possesses the same characteristics as (meth)acrylic compositions and polymeric (meth)acrylic compositions without any recycled raw materials, while having a reduced carbon footprint.

Surprisingly it has also been found that a (meth)acrylic composition MC1 comprising:
(a) 100 parts by weight of a liquid (meth)acrylic syrup having recycled content of at least 1 wt %, comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.01 part by weight to 5 parts by weight of a polymerization initiator,
(c) between 100 ppm and 10 000 ppm of an accelerator allows to provide a composition for the preparation of a (meth)acrylic polymeric composition MPC1 and (meth)acrylic polymeric composite material MPCM1 that possesses the same characteristics as (meth)acrylic compositions and polymeric (meth)acrylic compositions without any recycled raw materials, that is having a reduced carbon footprint, that polymerizes, and once polymerized yields to compositions that are recyclable.

Surprisingly it has also been found that a (meth)acrylic composition MC1 comprising:
(a) 100 parts by weight of a liquid (meth)acrylic syrup having recycled content of at least 1 wt %, comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.01 part by weight to 5 r weight of a polymerization initiator
(c) between 100 ppm and 10 000 ppm of an accelerator;
   allows to provide a composition for the preparation of (meth)acrylic polymeric compositions MPC1 and (meth)acrylic polymeric composite materials MPCM1 that possesses the same characteristics as (meth)acrylic compositions and polymeric (meth)acrylic compositions without any recycled raw materials, while having as well a reduced carbon food print.

Surprisingly it has been found that a process for preparing a (meth)acrylic composition MC1, said process is comprising the following steps:
(i) providing a (meth)acrylic polymer P1 and (meth)acrylic monomers M1 at least one of them is having a recycled content of 100%,
(ii) preparing 100 parts by weight of (a) a liquid (meth)acrylic syrup having a recycled content of at least 1 wt %, comprising:
   (a₁) from 18 by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
by mixing the components (a1) and (a2),
(iii) providing optionally from 0.01 part by weight to 5 parts by weight of a polymerization initiator
(iv) providing optionally between 100 ppm and 10 000 ppm of an accelerator;
   yields to a composition for the preparation of (meth)acrylic polymeric compositions MPC1 and (meth)acrylic polymeric composite materials MPCM1 that possesses the same characteristics as (meth)acrylic compositions and polymeric (meth)acrylic compositions without any recycled raw materials, while having a reduced carbon footprint.

### DETAILED DESCRIPTION OF THE INVENTION

According to a first aspect, the present invention relates to a (meth)acrylic composition MC1, said composition is comprising:
(a) 100 parts by weight of a liquid (meth)acrylic syrup having a recycled content of at least 1 wt& comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) optionally from 0.01 part by weight to 5 parts by weight of a polymerization initiator
(c) optionally between 100 ppm and 10 000 ppm of an accelerator.

According to a second aspect, the present invention relates to a (meth)acrylic composition MC1, said composition is comprising:
(a) 100 parts by weight of a liquid (meth)acrylic syrup having a recycled content of at least 1 wt % comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.01 part by weight to 5 parts by weight of a polymerization initiator,
(c) between 100 ppm and 10 000 ppm of an accelerator.

According to a third aspect, the present invention relates to a process for preparing a (meth)acrylic composition MC1 comprising following steps:
(i) providing providing a (meth)acrylic polymer P1 and (meth)acrylic monomers M1 at least one of them is having recycled content of at least 1 wt %,
(ii) preparing 100 parts by weight of (a) a liquid (meth)acrylic syrup having recycled content of at least 1 wt %, comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer, by mixing the components (a1) and (a2),
(iii) providing optionally from 0.01 part by weight to 5 parts by weight of a polymerization initiator
(iv) providing optionally between 100 ppm and 10 000 ppm of an accelerator,
(v) mixing the components.

According to a fourth aspect, the present invention relates to a process for preparing a (meth)acrylic composition MC1, process is comprising following steps:
(i) providing 100 parts by weight of (a) a liquid (meth)acrylic syrup having recycled content of at least 1 wt %, comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(ii) providing from 0.01 part by weight to 5 parts by weight of a polymerization initiator
(iii) providing between 100 ppm and 10 000 ppm of an accelerator,
(iv) mixing the components.

According to a fifth aspect the present invention relates to the use of a (meth)acrylic composition MC1 to prepare a (meth)acrylic polymeric material MPC1 or (meth)acrylic polymeric composite material MPCM1, said (meth)acrylic composition MC1 comprises:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.01 part by weight to 5 parts by weight of a polymerization initiator,
(c) between 100 ppm and 10 000 ppm of an accelerator.

According to a sixth aspect the present invention relates to a (meth)acrylic polymeric material MPC1 or (meth)acrylic polymeric composite material MPCM1 prepared by polymerization the (meth)acrylic composition MC1.

According to a seventh aspect the present invention relates to a process for preparing a (meth)acrylic polymeric material MPC1, said process comprises the following steps:
(i) providing a (meth)acrylic composition MC1 according to first or second aspect,
(ii) polymerizing the (meth)acrylic composition MC1.

According to an eight aspect the present invention relates to a process for preparing a (meth)acrylic polymeric composite material MPCM1, said process comprises the following steps:
(i) providing a (meth)acrylic composition MC1 according to first or second aspect,
(ii) bringing the (meth)acrylic composition MC1 in contact with a reinforcing material,
(iii) polymerizing the (meth)acrylic composition MC1.

According to a ninth aspect, the present invention relates to a process to reduce carbon food print of a (meth)acrylic composition MC1 comprising following steps:
(i) providing a (meth)acrylic polymer P1 and (meth)acrylic monomers M1 at least one of them is having recycled content of at least 1 wt %,
(ii) preparing 100 parts by weight of (a) a liquid (meth)acrylic syrup having recycled content of at least 1 wt %, comprising:
   (a₁) from 18 by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer, by mixing the components (a1) and (a2),
(iii) providing optionally from 0.01 part by weight to 5 parts by weight of a polymerization initiator
(iv) providing optionally between 100 ppm and 10 000 ppm of an accelerator,
(v) mixing the components.

According to a tenth aspect the present invention relates to the use of a (meth)acrylic composition MC1 to prepare a (meth)acrylic polymeric material MPC1 or (meth)acrylic polymeric composite material MPCM1 with a reduced carbon food print, said (meth)acrylic composition MC1 comprises:
(a) 100 parts by weight of a liquid (meth)acrylic syrup having a recycled content of at least 1 wt % comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.01 part by weight to 5 parts by weight of a polymerization initiator,
(c) between 100 ppm and 10 000 ppm of an accelerator.

According to an eleventh aspect the present invention relates to a process to reduce carbon food print of a (meth)acrylic polymeric material MPC1, said process comprises the following steps:
(i) providing a (meth)acrylic composition MC1 according to ninth aspect,
(ii) polymerizing the (meth)acrylic composition MC1.

According to a twelfth aspect the present invention relates to a process to reduce carbon food print of a (meth)acrylic polymeric composite material MPCM1, said process comprises the following steps:
(i) providing a (meth)acrylic composition MC1 according to ninth aspect,
(ii) bringing the (meth)acrylic composition MC1 in contact with a reinforcing material,
(iii) polymerizing the (meth)acrylic composition MC1.

According to a thirteenth aspect the present invention relates to the use of a (meth)acrylic composition MC1 to reduce the carbon print, said (meth)acrylic composition MC1 comprises:
(a) 100 parts by weight of a liquid (meth)acrylic syrup having a recycled content of at least 1 wt % comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.01 part by weight to 5 parts by weight of a polymerization initiator,
(c) between 100 ppm and 10 000 ppm of an accelerator.

The term “(meth)acrylic monomer” covers both an acrylic monomer and a methacrylic monomer. Similarly, the term “(meth)acrylic polymer” covers not only an acrylic homopolymer but also a methacrylic homopolymer, an acrylic copolymer and a methacrylic copolymer.

By the term “PMMA” as used are denoted homo- and copolymers of methylmethacrylate (MMA), for the copolymer of MMA the weight ratio of MMA inside the PMMA is at least 50 wt %.

By the term “initiator” as used is denoted a chemical species that forms compound or an intermediate compound that starts the polymerization of a monomer, that to capable of linking successively with a large number of other monomers into a polymeric compound.

By the term “polymer composite” as used is denoted a multicomponent material comprising multiple different phase domains in which at least one type of phase domain is a continuous phase and in which at least one component is a polymer.

By the term “thermoplastic” as used is denoted a polymer that turns to a liquid or becomes more liquid or less viscous when heated and that can take on new shapes by the application of heat and optionally pressure. This applies also for slightly crosslinked thermoplastic polymers that can be thermoformed when heated above the softening temperature.

By the term “recycled” as used in the present invention is denoted either a polymer or a monomer or both that is/are not a virgin material. The polymer can be production scraps or coming from waste more specifically polymeric waste, while the monomer is regenerated from thermochemical recycling of polymer waste. The polymeric waste can be post-industrial or post-consumer waste. Post-consumer waste of a material is a waste generated by a customer of a substrate containing the material. Postindustrial waste is waste generated during a production process of a product and has not used in the consumer market.

By the term “recycled content” as used is denoted the proportion by mass of material resulting from a recycled material.

By the term “carbon footprint” as used is denoted the weighted sum of greenhouse gas emissions and greenhouse gas removals of a process, a system of processes or a product system, expressed in CO₂ equivalents.

By saying that a range from x to y in the present invention, it is meant that the upper and lower limit of this range are included, equivalent to at least x and up to y.

By saying that a range is between x and y in the present invention, it is meant that the upper and lower limit of this range are excluded, equivalent to more than x and less than y.

The liquid (meth)acrylic syrup (a) of the composition according to the invention comprises (a₁) a (meth)acrylic polymer P1 and (a₂) a (meth)acrylic monomer M1 and the liquid (meth)acrylic syrup is having recycled content of at least 1 wt %. The recycled content of at least 1 wt& is coming either from the (meth)acrylic polymer P1 or the (meth)acrylic monomer M1 or both.

The liquid (meth)acrylic syrup (a) according to the (meth)acrylic composition MC1 of invention comprises between 1 wt % and 50 wt % of a (meth)acrylic polymer P1 and between 50 wt % and 99 wt % of a (meth)acrylic monomer M1.

Preferably the liquid (meth)acrylic syrup (a) comprises between 2 wt % and 50 wt % of a (meth)acrylic polymer P1 and between 50 wt % and 98 wt % of a (meth)acrylic monomer M1, more preferably between 2 wt % and 40 wt % of a (meth)acrylic polymer P1 and between 60 wt % and 98 wt % of a (meth)acrylic monomer M1, still more preferably between 3 wt % and 40 wt % of a (meth)acrylic polymer P1 and between 60 wt % and 97 wt % of a (meth)acrylic monomer M1, advantageously between 3 wt % and 35 wt % of a (meth)acrylic polymer P1 and between 65 wt % and 97 wt % of a (meth)acrylic monomer M1 and more advantageously between 3 wt % and 30 wt % of a (meth)acrylic polymer P1 and between 70 wt % and 97 wt % of a (meth)acrylic monomer M1.

The dynamic viscosity of the liquid (meth)acrylic syrup is in a range from 10 mPa*s to 10000 mPa*s, preferably from 20 mPa*s to 7000 mPa*s and advantageously from 20 mPa*s to 5000 mPa*s and more advantageously from 20 mPa*s to 2000 mPa*s and even more advantageously between 20 mPa*s and 1000 mPa*s. The viscosity of the syrup can be easily measured with a Rheometer or viscosimeter. The dynamic viscosity is measured at 25 °C. If the liquid (meth)acrylic syrup has a Newtonian behaviour, meaning no shear thinning, the dynamic viscosity is independent of the shearing in a rheometer or the speed of the mobile in a viscometer. If the liquid composition has a non-Newtonian behaviour, meaning shear thinning, the dynamic viscosity is measured at a shear rate of 1 s⁻¹ at 25 °C.

As regards the liquid (meth)acrylic syrup (a), it comprises (a₁) the (meth)acrylic monomer M1 and (a₂) the (meth)acrylic polymer P1. Once the (meth)acrylic composition MC1 has been polymerized, the (meth)acrylic monomer M1 polymerizes eventually with other (meth)acrylic monomers and is transformed to a (meth)acrylic polymer P2 comprising the monomeric units of (meth)acrylic monomer M1 and other possible comonomers.

The liquid (meth)acrylic syrup of the (meth)acrylic composition MC1 according to the invention may comprise only one (meth)acrylic polymer P1, but may equally comprise a mixture of two, three or even more (meth)acrylic polymers P1. If there is a mixture of different (meth)acrylic polymer P1, the difference is the composition of the respective (meth)acrylic polymer P1 or the molecular weight of the respective (meth)acrylic polymer P1 or both.

The or each (meth)acrylic polymer P1 included in the liquid (meth)acrylic syrup may in particular be chosen from:
polyalkyl acrylates which comprise alkyl acrylate homopolymers and alkyl acrylate copolymers, and
polyalkyl methacrylates which comprise alkyl methacrylate homopolymers and alkyl methacrylate copolymers.

According to a preferred embodiment, the or each (meth)acrylic polymer P1 is a polymethyl methacrylate (PMMA), it being understood that, as indicated above, the polymethyl methacrylate (PMMA) may denote a methyl methacrylate (MMA) homopolymer or an MMA copolymer.

In particular, in the case where the liquid (meth)acrylic syrup comprises a mixture of two or more polymethyl methacrylates P1, this mixture may be formed by mixing at least two MMA homopolymers having a different molecular weight, by mixing at least two MMA copolymers having an identical monomer composition and a different molecular weight, by mixing at least two MMA copolymers having a different monomer composition or by mixing at least one MMA homopolymer and at least one MMA copolymer.

According to a first preferred embodiment the (meth)acrylic polymer P1 is chosen from a methyl methacrylate homopolymer or a methyl methacrylate copolymer or a mixture thereof, methyl methacrylate advantageously representing at least 50% by weight of the or of each (meth)acrylic polymer P1.

According to one embodiment of the invention, methyl methacrylate represents at least 55% by weight of the or each (meth)acrylic polymer P1.

According to another particular embodiment, the or each (meth)acrylic polymer P1 comprises at least 70%, advantageously at least 80%, preferentially at least 90% and more preferentially at least 95% by weight of methyl methacrylate.

When the or each (meth)acrylic polymer P1 is a methyl methacrylate (MMA) copolymer, it may comprise at least one comonomer containing at least one ethylenic unsaturation and which is capable of copolymerizing with methyl methacrylate. Among these comonomers, mention may notably be made of acrylic and methacrylic acids and alkyl (meth)acrylates in which the alkyl group contains from 1 to 12 carbon atoms. Alkyl (meth)acrylates means an alkyl ester of acrylic acid or methacrylic acid As examples of comonomers, mention may be made of methyl acrylate and ethyl, butyl or 2-ethylhexyl (meth)acrylate.

Advantageously, the or each (meth)acrylic polymer P1 is a homopolymer of methyl methacrylate or a copolymer of methyl methacrylate and of an alkyl acrylate or an alkyl methacrylate in which the alkyl group contains from 1 to 12 carbon atoms, advantageously from 1 to 6 carbon atoms and preferentially from 1 to 4 carbon atoms.

According to a first preferred embodiment, when the or each (meth)acrylic polymer P1 is a methyl methacrylate (MMA) copolymer, this methyl methacrylate (MMA) copolymer comprises from 70% to 99.9%, advantageously from 80% to 99.9%, preferentially from 90% to 99.9% and more preferentially from 95% to 99.9% by weight of methyl methacrylate and from 0.1% to 30%, advantageously from 0.1% to 20%, preferentially from 0.1% to 10% and more preferentially from 0.1% to 5% by weight of at least one comonomer containing at least one ethylenic unsaturation that can copolymerize with methyl methacrylate. Preferably, the or each comonomer is chosen from methyl acrylate and ethyl acrylate.

In an advantageous variant of the first preferred embodiment, when the or each (meth)acrylic polymer P1 is a methyl methacrylate (MMA) copolymer, the (meth)acrylic polymer P1 is a copolymer of methyl methacrylate and of alkyl acrylate.

In a preferred variant of the first preferred embodiment, when the or each (meth)acrylic polymer P1 is a methyl methacrylate (MMA) copolymer, the (meth)acrylic polymer P1 is a copolymer of methyl methacrylate and of methyl acrylate or ethylacrylate.

According to a second preferred embodiment, when the or each (meth)acrylic polymer P1 is a methyl methacrylate (MMA) copolymer, this methyl methacrylate (MMA) copolymer comprises from 50% to 99.9%, advantageously from 52% to 99.9%, preferentially from 53% to 99.9% and more preferentially from 55% to 99.9% by weight of methyl methacrylate and from 0.1% to 50%, advantageously from 0.1% to 48%, preferentially from 0.18 to 47% and more preferentially from 0.1% to 45% by weight of at least one comonomer containing at least one ethylenic unsaturation that can copolymerize with methyl methacrylate. Preferably, the or each comonomer is chosen from methyl acrylate, ethyl acrylate, ethyl methacrylate, propyl acrylate, propyl methacrylate, butyl acrylate or butyl methacrylate.

The weight-average molecular weight, noted as Mw, of the or each (meth)acrylic polymer P1 is generally high and may consequently be greater than 40 000 g/mol, advantageously greater than 45 000 g/mol and preferentially greater than 50 000 g/mol. The weight-average molecular weight may be measured by size exclusion chromatography (SEC).

The (meth)acrylic polymer P1, if not crosslinked, usually has a melt mass-flow rate (MFR) ISO 1133-2:2011 (230 °C/3.8 kg) of between 0.1 g/10 min and 20 g/10 min or the melt mass-flow rate is between 0.2 g/10 min and 18 g/10 min, or between 0.3 g/10 min and 16 g/10 min or between 0.4 g/10 min and 13 g/10 min.

The liquid (meth)acrylic syrup of the (meth)acrylic composition MC1 according to the invention may comprise only one (meth)acrylic monomer M1, but may equally comprise a mixture of two, three or even more (meth)acrylic monomers M1. This would be (meth)acrylic monomer M1a, (meth)acrylic monomer M1b, (meth)acrylic monomers M1c and so on.

Whether the liquid (meth)acrylic syrup comprises one or more (meth)acrylic monomers M1, the or each (meth)acrylic monomer M1 comprises only one (meth)acrylic function per monomer.

As regards the (meth)acrylic monomer M1, the monomer is chosen from alkyl acrylic monomers, alkyl methacrylic monomers, hydroxyalkyl acrylic monomers and hydroxyalkyl methacrylic monomers, and mixtures thereof. Alkyl acrylic monomer or alkyl methacrylic monomer means an alkyl ester of acrylic acid or methacrylic acid.

Preferably, the (meth)acrylic monomer M1 is chosen from hydroxyalkyl acrylic monomers, hydroxyalkyl methacrylic monomers, alkyl acrylic monomers, alkyl methacrylic monomers and mixtures thereof, the alkyl group containing from 1 to 22 linear, branched or cyclic carbons; the alkyl group preferably containing from 1 to 12 linear, branched or cyclic carbons.

Advantageously, the (meth)acrylic monomer M1 is chosen from methyl methacrylate, ethyl methacrylate, methyl acrylate, ethyl acrylate, n-butyl acrylate, isobutyl acrylate, n-butyl methacrylate, isobutyl methacrylate, cyclohexyl acrylate, cyclohexyl methacrylate, isobornyl acrylate, isobornyl methacrylate, hydroxyethyl acrylate and hydroxyethyl methacrylate, and mixtures thereof.

According to a preferred embodiment, at least 50% by weight and preferably at least 60% by weight of the (meth)acrylic monomer M1 is methyl methacrylate.

According to a first more preferred embodiment, at least 50% by weight, preferably at least 60% by weight, more preferably at least 70% by weight, advantageously at least 80% by weight and even more advantageously 90% by weight of the monomer M1 is a mixture of methyl methacrylate with optionally at least one other monomer.

According to a second more preferred embodiment the monomer M1 is methyl methacrylate.

In a first variant of the invention, the liquid (meth)acrylic syrup comprises:
(a₁) from 3% by weight to 45% by weight and preferentially from 3% by weight to 40% by weight of the (meth)acrylic polymer(s) P1, and
(a₂) from 55% by weight to 97% by weight and preferentially from 60% by weight to 97% by weight of the (meth)acrylic monomer(s) M1.

In a second variant of the invention, the liquid (meth)acrylic syrup comprises:
(a₁) from 10% by weight to 35% by weight and preferentially from 12% by weight to 35% by weight and more preferentially from 15% by weight to 30% by weight and even more preferentially from 20% by weight to 30% by weight of the (meth)acrylic polymer(s) P1, and
(a₂) from 65% by weight to 90% by weight and preferentially from 65% by weight to 88% by weight and more preferentially from 70% by weight to 85% by weight and even more preferentially from 70% by weight to 80% by weight of the (meth)acrylic monomer(s) M1.

In an advantageous variant, the or each (meth)acrylic polymer P1 and the or each (meth)acrylic monomer M1 of f the liquid (meth)acrylic syrup comprise at least one same (meth)acrylic unit, such a variant making it possible to optimize the solubility of the (meth)acrylic polymer(s) P1 in the (meth)acrylic monomer(s) M1.

Preferentially, the or each (meth)acrylic polymer P1 is chosen from a homopolymer of methyl methacrylate or copolymer of methyl methacrylate and of methyl acrylate and a copolymer of methyl methacrylate and of ethyl acrylate or a copolymer of methyl methacrylate and of butyl acrylate or a copolymer of methyl methacrylate and of butyl methacrylate, the respective comonomer being present at most at 45 wt % in the copolymer.

Preferentially, the (meth)acrylic monomer M1 is methyl methacrylate.

In a first advantageous variant, the liquid (meth)acrylic syrup comprises a (meth)acrylic polymer P1, rather than a mixture of (meth)acrylic polymers P1.

In a second advantageous variant, the liquid (meth)acrylic syrup comprises a mixture of two (meth)acrylic polymers P1.

In another advantageous variant, the liquid (meth)acrylic syrup comprises a (meth)acrylic monomer M1, rather than a mixture of (meth)acrylic monomers M1.

Stabilizers, or reaction inhibitors, may also be present in the liquid (meth)acrylic syrup to prevent spontaneous polymerization of the (meth)acrylic monomer(s) M1.

These stabilizers may notably be chosen from hydroquinone (HQ), hydroquinone monomethyl ether (HOME), 2,6-di-tert-butyl-4-methylphenol (BHT), 2,6-di-tert-butyl-4-methoxyphenol (Topanol O) and 2,4-dimethyl-6-tert-butylphenol (Topanol A).

These stabilizers may be present, in the liquid (meth)acrylic syrup, in a proportion of not more than 5 parts by weight, advantageously not more than 4 parts by weight and preferentially in a proportion of between 0.3 and 3 parts by weight, per 100 parts by weight of the sum of the (meth)acrylic polymer(s) P1 and of the (meth)acrylic monomer(s) M1.

As regards the recycled content of at least 1 wt %, it can be coming either from the (meth)acrylic polymer P1 or the (meth)acrylic monomer M1 or both. The recycled content is expressed on the basis of the sum of components (a₁) and (a₂) of the liquid (meth)acrylic syrup.

In a first preferred embodiment, the recycled content is at least 10 wt %.

In a second preferred embodiment, the recycled content is at least 20 wt %.

In a third preferred embodiment, the recycled content is at least 50 wt %.

In a fourth preferred embodiment, the recycled content is between 15 wt % and 100 wt %.

In a fifth preferred embodiment, the recycled content is from 20 wt % to 100 wt %.

In a sixth preferred embodiment, the recycled content is from 50 wt % to 100 wt %.

In a seventh preferred embodiment, the recycled content is 100 wt %.

In an eighth preferred embodiment, the recycled content of the liquid (meth)acrylic syrup is only coming from the (meth)acrylic polymer P1.

In a ninth preferred embodiment, the recycled content of the liquid (meth)acrylic syrup is only coming from the (meth)acrylic monomer M1.

In a tenth preferred embodiment, the recycled content of the liquid (meth)acrylic syrup is coming from the (meth)acrylic polymer P1 and the (meth)acrylic monomer M1.

In in eleventh preferred embodiment, the (meth)acrylic polymer P1 of the component (a₁) of the liquid (meth)acrylic syrup is only partly recycled. By that is meant that from 18 by weight to 50% by weight of one or more (meth)acrylic polymers P1, there is a mixture of at least two (meth)acrylic polymers P1, one is a recycled and one not.

In a twelfth, the (meth)acrylic monomer M1 of the component (a₂) of the liquid (meth)acrylic syrup is only partly recycled. By that is meant that from 50% by weight to 99% by weight of one or more (meth)acrylic monomer M1, there is a mixture of at least two (meth)acrylic monomer M1, one is a recycled and one not.

The respective preferred embodiments are combinable in any logical combination.

The (meth)acrylic polymer P1 as recycled component is coming from waste, preferably post-industrial or post-consumer waste.

The (meth)acrylic monomer M1 as recycled component is coming from depolymerization of a (meth)acrylic polymer comprising (meth)acrylic monomer M1. In the case where the monomer (M1) is methyl methacrylate, it is obtained by depolymerization of polymethyl methacrylate (PMMA).

The (meth)acrylic composition MC1 according to one aspect of the invention also comprises a polymerization initiator, the function of which is to ensure the start of polymerization of the (meth)acrylic monomer M1.

The polymerization initiator may be chosen from organic peroxides, peroxy esters, peroxy acetals and azo compounds.

The polymerization initiator may in particular be chosen from diacyl peroxides, peroxy esters, peroxydicarbonates, dialkyl peroxides, peroxyacetals, hydroperoxide or peroxyketale.

In one embodiment, the polymerization initiator is chosen from benzoyl peroxide.

In another embodiment the polymerization initiator is chosen from diisobutyryl peroxide, cumyl peroxyneodecanoate, di (3-methoxybutyl) peroxydicarbonate, 1,1,3,3-Tetramethylbutyl peroxyneodecanoate, cumyl peroxyneoheptanoate, di-n-propyl peroxydicarbonate, tert-amyl peroxyneodecanoate, 1 di-sec-butyl peroxydicarbonate, diisopropyl peroxydicarbonate, di (4-tert-butylcyclohexyl) peroxydicarbonate, di-(2-ethylhexyl)-peroxydicarbonate, tert-amyl peroxyneodecanoate, tert-butyl peroxyneodecanoate, di-n-butyl peroxydicarbonate, dicetyl peroxydicarbonate, dimyristyl peroxydicarbonate, 1,1,3,3-tetramethylbutylperoxypivalate, tert-butyl peroxyneoheptanoate, tert-amyl peroxypivalate, tert-butyl peroxypivalate, di-(3,5,5-trimethylhexanoyl)-peroxide, dilauroyl peroxide, didecanoyl peroxide, 2,5-dimethyl-2,5-di(2-ethylhexanoylperoxy)-hexane, 1,1,3,3-tetramethylbutyl peroxy-2-ethylhexanoate, tert-amyl peroxy-2-ethylhexanoate, dibenzoyl peroxide, tert-butyl peroxy-2-ethylhexanoate, tert-butyl peroxydiethylacetate, tert-butyl peroxyisobutyrate, 1,1-di-(tert-butylperoxy)-3,3,5-trimethylcyclohexane, 1,1-di(tert-amylperoxy)cyclohexane, 1,1-di-(tert-butylperoxy)-cyclohexane, tert-amyl peroxy-2-ethylhexylcarbonate, tert-amyl peroxyacetate, tert-butyl peroxy-3,5,5-trimethylhexanoate, 2,2-di-(tert-butylperoxy)-butane, tert-butyl peroxyisopropylcarbonate, tert-butyl peroxy-2-ethylhexylcarbonate, tert-amyl peroxybenzoate, tert-butyl peroxyacetate, butyl 4,4-di(tert-butylperoxy) valerate, tert-butyl peroxybenzoate, di-tert-amylperoxide, dicumyl peroxide, di-(2-tert-butyl-peroxyisopropyl)-benzene, 2,5-dimethyl-2,5-di-(tert-butylperoxy)-hexane, tert-butylcumyl peroxide, 2,5-dimethyl-2,5-di(tert-butylperoxy) hexyne-3, di-tert-butyl peroxide, 3,6,9-triethyl-3,6,9-trimethyl-1,4,7-triperoxonane, 2,2′-azobis-isobutyronitrile (AIBN), 2,2′-azodi-(2-methylbutyronitrile), azobisisobutyramide, 2,2′-azobis(2,4-dimethylvaleronitrile), 1,1′-Azodi (hexahydrobenzonitrile), or 4,4′-azobis(4-cyanopentanoic).

The (meth)acrylic composition MC1 according to the invention may comprise from 0.01 part by weight to 5 parts by weight of polymerization initiator.

According to a particular embodiment, the (meth)acrylic composition MC1 according to the invention comprises from 0.02 part by weight to 4 parts by weight and advantageously 0.03 part by weight to 3 parts by weight of polymerization initiator per 100 parts by weight of the liquid (meth)acrylic syrup.

That which has just been described for a polymerization initiator is entirely transposable to an initiator system, such a system consisting of a polymerization initiator and a polymerization activator or accelerator.

The (meth)acrylic composition MC1 according to the invention may also effectively further according to certain aspects comprise a polymerization activator or accelerator.

According to a particular embodiment, the (meth)acrylic composition according to the invention comprises between 100 ppm and 10 000 ppm, advantageously between 100 ppm and 7 000 pmm and preferably 000 ppm between 200 ppm and 5 of polymerization activator or accelerator per 100 parts by weight of the (meth)acrylic syrup.

The present invention relates also to a process for preparing a (meth)acrylic composition MC1.

According to the invention, this process comprises the steps: providing the respective components and iv) mixing the components.

Step iv) of the preparing process according to the invention is performed by mixing all of the components included in the (meth)acrylic composition MC1. In one embodiment care is being taken to prepare, firstly, the liquid (meth)acrylic syrup and then to introduce, into this (meth)acrylic syrup where appropriate, the polymerization activator or accelerator, the polymerization initiator being introduced last.

This mixing may be manual or may be performed using a mixing means.

Optionally, the mixing is performed by stirring, and for a time of between 1 minutes and 36 hours, advantageously between 2 minutes and 24 hours, more advantageously between 3 minutes and 24 hours and preferentially between 4 minutes and 24 hours.

The manufacturing process according to the invention is thus a process that is particularly simple to perform and which may be readily performed in the current facilities dedicated to the manufacture of (meth)acrylic composition.

The (meth)acrylic composition MC1 comprising the compounds a1) to a2) or the optionally other added components has a viscosity between 10 mPa*s and 10 000 mPa*s at 23 °C.

Preferably the viscosity of (meth)acrylic composition MC1 comprising the compounds al) to a2) at 23 °C is in a range from 50 mPa*s to 10 000 mPa*s, more preferably from 50 mPa*s to 9 000 mPa*s, still more preferably from 50 mPa*s to 8 000 mPa*s, even still more preferably from 50 mPa*s to 7 500 mPa*s, even still more preferably between 50 mPa*s and 7 000 mPa*s, advantageously between 50 mPa*s and 6 000 mPa*s and more advantageously between 50 mPa*s and 5 000 mPa*s.

The process to prepare the (meth)acrylic composition MC1 according to any embodiment can optionally additionally comprise an filtration step of liquid (meth)acrylic syrup having recycled content of at least 1 wt %. The filtration step is preferably made before the mixing with polymerization initiator.

In one embodiment, the reinforcing material is fibrous substrate.

In another embodiment, the reinforcing material is a mineral filler.

The present invention relates in an additional aspect to a moulded part MP1 comprising a (meth)acrylic polymeric composite material MPCM1.

In a first preferred embodiment the (meth)acrylic polymeric composite material 1 MPCM1 is a fiber reinforced (meth)acrylic polymeric composite material.

In a second preferred embodiment the (meth)acrylic polymeric composite material MPCM1 is a particle reinforced (meth)acrylic polymeric composite material.

### Methods

The weight-average molecular weight may be measured by size exclusion chromatography (SEC). The chromatography column is calibrated with PMMA standards having a molecular weight between 402 g/mol and 1 900 000 g/mol. The average molecular weight is expressed in g/mol for the number and average molecular weight Mn and Mw respectively. For the measurement, the concentration is 1 g/L.

The viscosity of the (meth)acrylic compositions comprising at least the components al) and a2) is measured with a Brookfield viscosimeter at 23 °C, according to ISO 2555:2018 “Plastics—Resins in the liquid state or as emulsions or dispersions-Determination of apparent viscosity using a single cylinder type rotational viscometer method”.

Stability is measured with following method. Temper an oven at 90 °C. Pour 200 g of the liquid resin in a bottle. Place the sealed bottle in the oven. Check periodically sample. A thermocouple can be used in order to follow the temperature of the sample along the stability test. Sample is considered “conform”, meaning stable, if the resin remains liquid after 24 h at 90 °C and if no exothermic peak is observed during this time. By remaining liquid is meant that the viscosity does no pass 20 Pa*s at 23 °C.

Reactivity is measured with following method. A 20×180 mm test tube is filled to a height of 7.5 cm with liquid syrup and added initiator and accelerator. A thermocouple is placed in the syrup. Tube is immersed at least 140 mm in a water bath at 25 °C. Temperature is continuously measured and the time to temperature peak is taken.

### EXAMPLES

The compounds used for the preparation of the various (meth)acrylic compositions are the following:
as (meth)acrylic polymer P1: a PMMA formed by a copolymer of methyl methacrylate and of ethyl acrylate, from company Altuglas under the name Altuglas® BS 520B, abbreviated P1-F,
as a recycled (meth)acrylic polymer P1 is used a production scrab PMMA having the same molecular weight as BS 520B (used as measured by size exclusion chromatography (SEC), abbreviated P1-R,
as (meth)acrylic monomer M1: a methyl methacrylate stabilized with hydroquinone monomethyl ether, abbreviated M1-F,
as a recycled (meth)acrylic monomer M1: a methyl methacrylate from the company Monomeros del Valles is used, abbreviated M1-R
as initiator benzoyl peroxide (BPO) is used,
as accelerator DMPT (N, N-dimethyl-p-toluidine) is used.

Four syrups are prepared by first dissolving 20 parts by weight of respective (meth)acrylic polymer P1 in 80 parts by weight of respective (meth)acrylic monomer M1, according to table 1.

TABLE 1
compositions of the respective liquid (meth)acrylic syrups samples

| | Sample 1 | Sample 2 | Sample 3 | Sample 4 |
|---|---|---|---|---|
| P1-F | 20 wt % | | 20 wt % | |
| P1-R | | 20 wt % | | 20 wt % |
| M1-F | 80 wt % | 80 wt % | | |
| M1-R | | | 80 wt % | 80 wt % |
| recycled | 0 wt % | 20 wt % | 80 wt % | 100 wt % |
| content | | | | |
| Kg CO₂/kg | 3.60 | 2.97 | 1.20 | 0.57 |
| Syrup | | | | |

The characteristics of the four sample syrups are given in table 2.

TABLE 2
properties of liquid (meth) acrylic syrup

| | Value or | | | Sample | Sample | Sample | Sample |
|---|---|---|---|---|---|---|---|
| | range | | Method | 1 | 2 | 3 | 4 |
| Coloration | <15 | Hazen | ISO 6271 | Yes | Yes | Yes | Yes |
| Stability | >24 | h | Internal | Yes | Yes | Yes | Yes |
| Viscosity | 80-120 | mPa*s | IS 2555 | Yes | Yes | Yes | Yes |
| Reactivity | 30-45 | min | Internal | Yes | Yes | Yes | Yes |

As can be seen in table 2, for the three samples with recycled content have the characteristics as the comparative sample using (meth)acrylic polymer P1 and (meth)acrylic monomer M1 from fossil origin.

Initiator and accelerator are added to the respective samples: 3 parts of BPO are added and 4 000 ppm of DMPT.

The four sample syrups are polymerized in order to prepare a (meth)acrylic polymeric composition. A cast sheet process is used.

TABLE 3
Properties (meth) acrylic polymeric composition obtained
from polymerized liquid (meth) acrylic syrup

| | | | From | From | From | From |
|---|---|---|---|---|---|---|
| | | | Sample | Sample | Sample | Sample |
| | unit | Method | 1 | 2 | 3 | 4 |
| Heat | °C | ISO 75 | 110 | 112 | 111 | 112 |
| Deflection | | | | | | |
| Temperature | | | | | | |
| Shore D | — | ISO 868 | 85 | 84 | 85 | 87 |
| Hardness | | | | | | |
| Water Uptake | % | ISO 62 | 0.5 | 0.5 | 0.5 | 0.5 |
| 7 days at | | | | | | |
| 23 °C | | | | | | |
| Tensile | MPa | ISO 527 | 66 | 67 | 67 | 65 |
| Strength | | | | | | |
| Tensile | GPa | ISO 527 | 3.2 | 3.2 | 3.2 | 3.1 |
| Modulus | | | | | | |
| Tensile | % | ISO 527 | 2.8 | 2.8 | 2.9 | 2.8 |
| Elongation | | | | | | |
| at Break | | | | | | |
| Flexural | MPa | ISO 178 | 111 | 112 | 110 | 113 |
| Strength | | | | | | |
| Flexural | GPa | ISO 178 | 2.9 | 2.8 | 2.9 | 3.0 |
| Modulus | | | | | | |
| Compression | MPa | ISO 604 | 116 | 114.8 | 116.0 | 113.7 |
| Strength | | | | | | |
| Compression | GPa | ISO 604 | 3.8 | 3.7 | 3.8 | 3.8 |
| Modulus | | | | | | |

The four samples are used to infuse a fibrous substrate and polymerized after infusion. The fibrous substrate represents 50 vol % of the obtained (meth)acrylic polymeric composite material. As fibrous substrate is used a non-CRIMP glass fabric (NCF-non crimp fabric) with 600 g/m².

The obtained polymeric (meth)acrylic composite was analysed for mechanical properties.

First series of measurements were made at an angle+/−45° towards the fiber direction. The results obtained as summarized in table 4.

Second series of measurements were made at an angle 0°/90° towards the fiber direction. The results obtained as summarized in table 5.

TABLE 4
Properties (meth) acrylic polymeric composite obtained
from polymerized liquid (meth) acrylic syrup after
infusion at an angle +/−45°

| | | | From | From | From | From |
|---|---|---|---|---|---|---|
| | | | Sample | Sample | Sample | Sample |
| | unit | Method | 1 | 2 | 3 | 4 |
| Tensile | MPa | ISO | 206 | 200 | 208 | 204 |
| Strength | | 14129 | | | | |
| Tensile | GPa | ISO | 11 | 11 | 11 | 11 |
| Modulus | | 14129 | | | | |
| Tensile | % | ISO | no | no | no | no |
| Elongation | | 14129 | break | break | break | break |
| at Break | | | | | | |

TABLE 5
Properties (meth) acrylic polymeric composite obtained from polymerized
liquid (meth) acrylic syrup after infusion at an angle 0°/90°

| | | | From | From | From | From |
|---|---|---|---|---|---|---|
| | | | Sample | Sample | Sample | Sample |
| | unit | Method | 1 | 2 | 3 | 4 |
| Tensile | MPa | ISO 527 | 695 | 653 | 688 | 709 |
| Strength | | | | | | |
| Tensile | GPa | ISO 527 | 20 | 18 | 20 | 20 |
| Modulus | | | | | | |
| Tensile | % | ISO 527 | 4.5 | 4.5 | 4 | 4.6 |
| Elongation | | | | | | |
| at Break | | | | | | |
| Flexural | MPa | ISO | 732 | 725 | 747 | 717 |
| Strength | | 14125 | | | | |
| Flexural | GPa | ISO | 19 | 19 | 19 | 19 |
| Modulus | | 14125 | | | | |

Table 4 and 5 show no significant change in any mechanical property of the composite material.

1. A (meth)acrylic composition MC1 comprising:
(a) 100 parts by weight of a liquid (meth)acrylic syrup a having recycled content of at least 1 wt % comprising:
(1) from 1% by weight to 50% by weight of one or more (meth)acrylic polymers P1, and
(2) from 50% by weight to 99% by weight of one or more (meth)acrylic monomers M1, each monomer M1 comprising only one (meth)acrylic function per monomer,
(b) optionally from 0.01 part by weight to 5 parts by weight of a polymerization initiator, and
(c) optionally between 100 ppm and 10,000 ppm of an accelerator.

2. The (meth)acrylic composition MC1 according to claim 1, wherein the liquid (meth)acrylic syrup comprises:
(1) from 10% by weight to 35% by weight and preferentially from 12% by weight to 35% by weight and more preferentially from 15% by weight to 30% by weight and even more preferentially from 20% by weight to 30% by weight of the (meth)acrylic polymer(s) P1, and
(2) from 65% by weight to 90% by weight and preferentially from 65% by weight to 88% by weight and more preferentially from 70% by weight to 85% by weight and even more preferentially from 70% by weight to 80% by weight of the (meth)acrylic monomer(s) M1.

3. The (meth)acrylic composition MC1 according to claim 1, wherein it comprises
(d) from 0.01 part by weight to 5 parts by weight of a polymerization initiator (d) between 100 ppm and 10,000 ppm of an accelerator.

4. (canceled)

5. (canceled)

6. The (meth)acrylic composition MC1 according to claim 1, wherein the recycled content is from 20 wt % to 100 wt %.

7. (canceled)

8. The composition according to claim 1, wherein the recycled content of at least 1 wt % is coming either from the (meth)acrylic polymer P1 or the (meth)acrylic monomer M1 or both.

9. (canceled)

10. (canceled)

11. The composition according to claim 1, wherein the or each (meth)acrylic polymer P1 is chosen from a methyl methacrylate homopolymer or a methyl methacrylate copolymer or a mixture thereof, methyl methacrylate advantageously representing at least 50% by weight of the or of each (meth)acrylic polymer P1.

12. The composition according to any claim 1, wherein the or each (meth)acrylic polymer P1 (meth)acrylic polymer P1 comprises at least 70%, advantageously at least 80%, preferentially at least 90% and more preferentially at least 95% by weight of methyl methacrylate.

13. The composition according to claim 1, wherein the liquid (meth)acrylic syrup has a viscosity between 10 m*Pas and 10,000 mPa*s at 25 °C.

14. (canceled)

15. The composition according to claim 1, wherein at least 70% by weight, advantageously at least 80% by weight and even more advantageously 90% by weight of the monomer M1 is a mixture of methyl methacrylate with optionally at least one other monomer.

16. (canceled)

17. The composition according to claim 1, wherein weight-average molecular weight Mw of the or each (meth)acrylic polymer P1 is greater than 40,000 g/mol, advantageously greater than 45,000 g/mol and preferentially greater than 50,000 g/mol.

18. The composition according to claim 1, wherein the (meth)acrylic polymer P1 has a melt mass-flow rate (MFR) ISO 1133-2:2011 (230 °C/3.8 kg) of between 0.1 g/10 min and 20 g/10 min or the melt mass-flow rate is between 0.2 g/10 min and 18 g/10 min, or between 0.3 g/10 min and 16 g/10 min or between 0.4 g/10 min and 13 g/10 min.

19. A process to prepare the (meth)acrylic composition MC1 according to claim 1, comprising the following steps
(i) providing a (meth)acrylic polymer P1 and (meth)acrylic monomers M1 at least one of them is having recycled content of 100%,
(ii) preparing 100 parts by weight of (a) a liquid (meth)acrylic syrup having recycled content of at least 1 wt %, comprising:
(1) from 1% by weight to 50% by weight of one or more (meth)acrylic polymers P1, and
(2) from 50% by weight to 99% by weight of one or more (meth)acrylic monomers M1, each monomer M1 comprising only one (meth)acrylic function per monomer,
by mixing the components (1) and (2),
(iii) providing optionally from 0.01 part by weight to 5 parts by weight of a polymerization initiator
(iv) providing optionally between 100 ppm and 10,000 ppm of an accelerator,
(v) mixing the components.

20. A process to prepare the (meth)acrylic composition MC1 according to claim 1, comprising the following steps
(i) providing 100 parts by weight of (a) a liquid (meth)acrylic syrup having recycled content of at least 1 wt %, comprising:
(1) from 1% by weight to 50% by weight of one or more (meth)acrylic polymers P1, and)
(2) from 50% by weight to 99% by weight of one or more (meth)acrylic monomers M1, each monomer M1 comprising only one (meth)acrylic function per monomer,
(ii) providing from 0.01 part by weight to 5 parts by weight of a polymerization initiator,
(iii) providing between 100 ppm and 10,000 ppm of an accelerator,
(iv) mixing the components.

21. The process according to claim 19, wherein the process additionally comprise a filtration step of the liquid (meth)acrylic syrup having recycled content of at least 1 wt %.

22. A process to reduce the carbon footprint of a (meth)acrylic composition MC1 comprising following steps:
(i) providing a (meth)acrylic polymer P1 and (meth)acrylic monomers M1 at least one of them is having recycled content of at least 1 wt %,
(ii) preparing 100 parts by weight of (a) a liquid (meth)acrylic syrup having recycled content of at least 1 wt %, comprising:
(1) from 1% by weight to 50% by weight of one or more (meth)acrylic polymers P1, and
(2) from 50% by weight to 99% by weight of one or more (meth)acrylic monomers M1, each monomer M1 comprising only one (meth)acrylic function per monomer,
by mixing the components,
(iii) providing optionally from 0.01 part by weight to 5 parts by weight of a polymerization initiator
(iv) providing optionally between 100 ppm and 10,000 ppm of an accelerator,
(v) mixing the components.

23. (canceled)

24. (canceled)

25. A (meth)acrylic polymeric material prepared by polymerization of the (meth)acrylic composition MC1 according to claim 1.

26. (canceled)

27. A (meth)acrylic polymeric composite material prepared by polymerization of the (meth)acrylic composition MC1 according to claim 1.

28. A process to prepare a (meth)acrylic polymeric material comprising the following steps:
(i) providing a (meth)acrylic composition MC1 according to claim 1,
(ii) polymerizing the (meth)acrylic composition MC1.

29. A process to reduce the carbon footprint of a (meth)acrylic polymeric material comprising the following steps:
(i) providing a (meth)acrylic composition MC1 according to claim 1,
(ii) polymerizing the (meth)acrylic composition MC1.

30. A process to prepare a (meth)acrylic polymeric composite material MCPM1 comprising the following steps:
(i) providing a (meth)acrylic composition MC1 according to claim 1,
(ii) bringing the (meth)acrylic composition MC1 in contact with reinforcing material,
(iii) polymerizing the (meth)acrylic composition MC1.

31. A process to reduce the carbon footprint of a (meth)acrylic polymeric composite material MPCM1, said process comprises the following steps:
(i) providing a (meth)acrylic composition MC1 according to according to claim 1,
(ii) bringing the (meth)acrylic composition MC1 in contact with a reinforcing material,
(iii) polymerizing the (meth)acrylic composition MC1.

32. The process according to claim 30, wherein the reinforcing material is a fibrous substrate.
